(19) United States
(12) Patent Application Publication
(10) Pub. No.: US 2005/0101292 A1
(43) Pub. Date: May 12, 2005

(54) Charging system based on user location

(75) Inventor: Satoru Fukui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/014,882

(22) Filed: Dec. 20, 2004

Related U.S. Application Data
(63) Continuation of application No. PCT/JP02/13343, filed on Dec. 20, 2002.

(51) Int. Cl. H04Q 7/20

(52) U.S. Cl. 455/406; 455/405

(57) ABSTRACT

A terminal apparatus which a user holds detects location information of the user, and transmits the location information to a management server. The management server determines whether the user is within a specific area based on the location information. When the user is in the specific area, the management server offers a service at a discount rate based on service contents registered in a storage device beforehand, and bills an entrepreneur in the specific area an amount corresponding to the discount rate as a share amount.

### CROSS-REFERENCE TO RELATED APPLICATION

This application is a continuation of an International Application No. PCT/JP02/13343, which was filed on Dec. 20, 2002.

### BACKGROUND OF THE INVENTION

1. Field of the Invention

The present invention relates to a charging system based on a user location that uses a network such as the Internet and charges a user on the basis of user location information.

2. Description of the Related Art

Today, a variety of services are provided as services using a network such as the Internet. These are, for example, services such as chargeable services for cellular phones, web services for mobile terminals.

Among the above services, as a service using location information of a user in particular, a charging system that uses a public telephone line and changes a charge based on the location information of the user is suggested (for example, patent document 1). In the patent document 1, a technology for varying a charge based on a caller location in mobile communications such as a cellular phone and PHS (personal handy phone system) and lowering a charge for use at a place where it is often used such as a home is disclosed.

Patent document 1: Japanese Patent Laid-open No. 2000-287000

However, the above conventional technique is used limited to a charge to the caller and a charging system thereof is performed conventionally.

### SUMMARY OF THE INVENTION

According to the present invention, a charge system is constructed such that the system sets up a plurality of specific areas and acquires location information of a user and enables the user to receive a service at a predetermined discount rate in a database in the case where the user is in one of the specific areas. Further, the system is constructed such that an area entrepreneur in the specific areas pays a share amount corresponding to the discount rate to a service center which offers the service.

### BRIEF DESCRIPTION OF THE DRAAWINGS

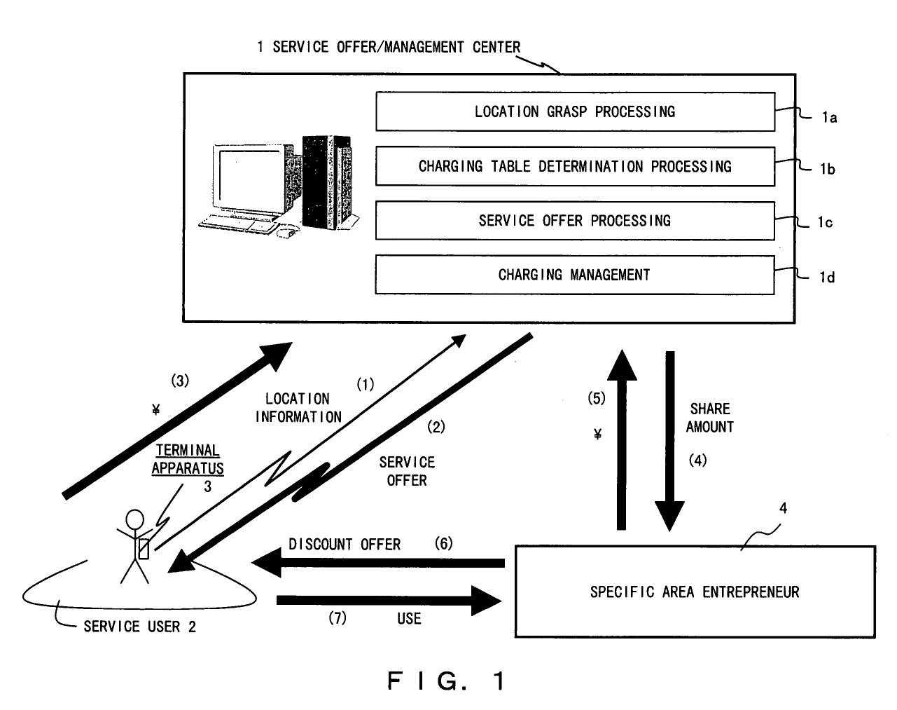

FIG. 1 is a diagram generally illustrating the configuration of a charging system based on a user location according to the present invention.

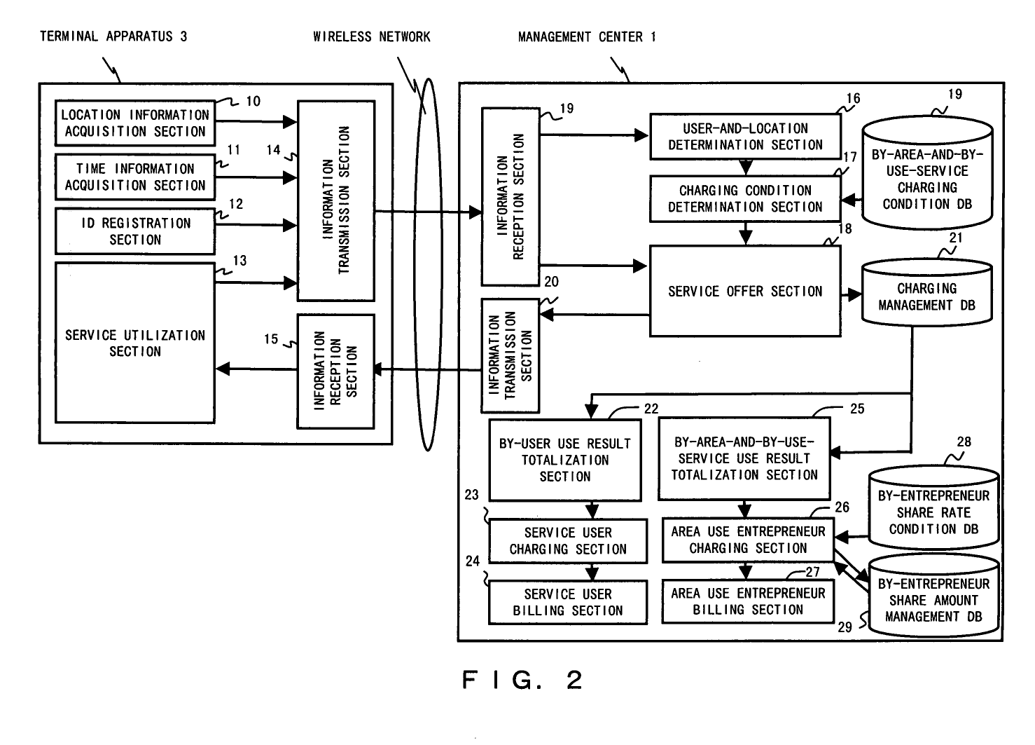

FIG. 2 is an explanatory diagram showing the system configuration of a service offer/management center and a terminal apparatus.

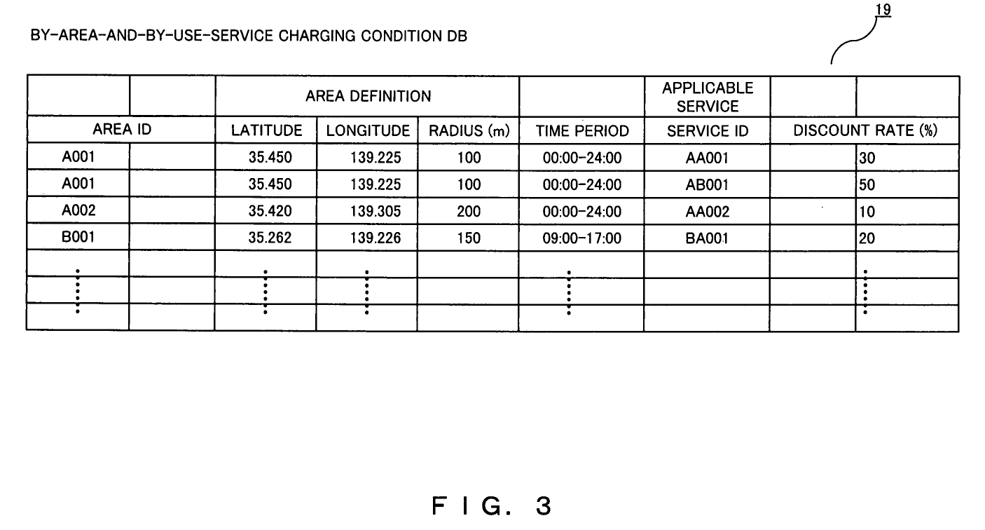

FIG. 3 is a diagram showing a structure example of a by-area-and-by-use-service charging condition database (DB).

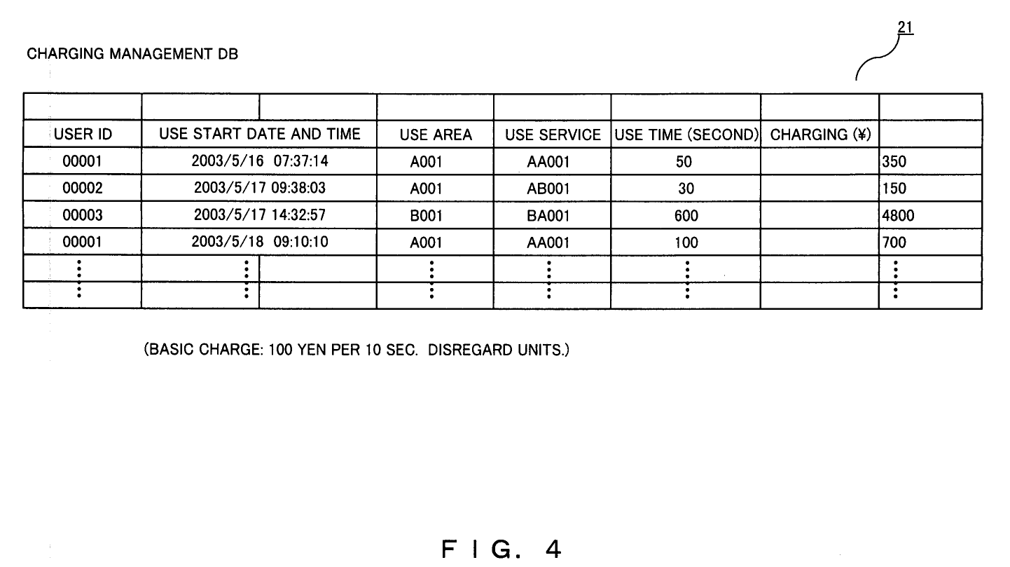

FIG. 4 is a diagram showing a structure example of a charging management database (DB).

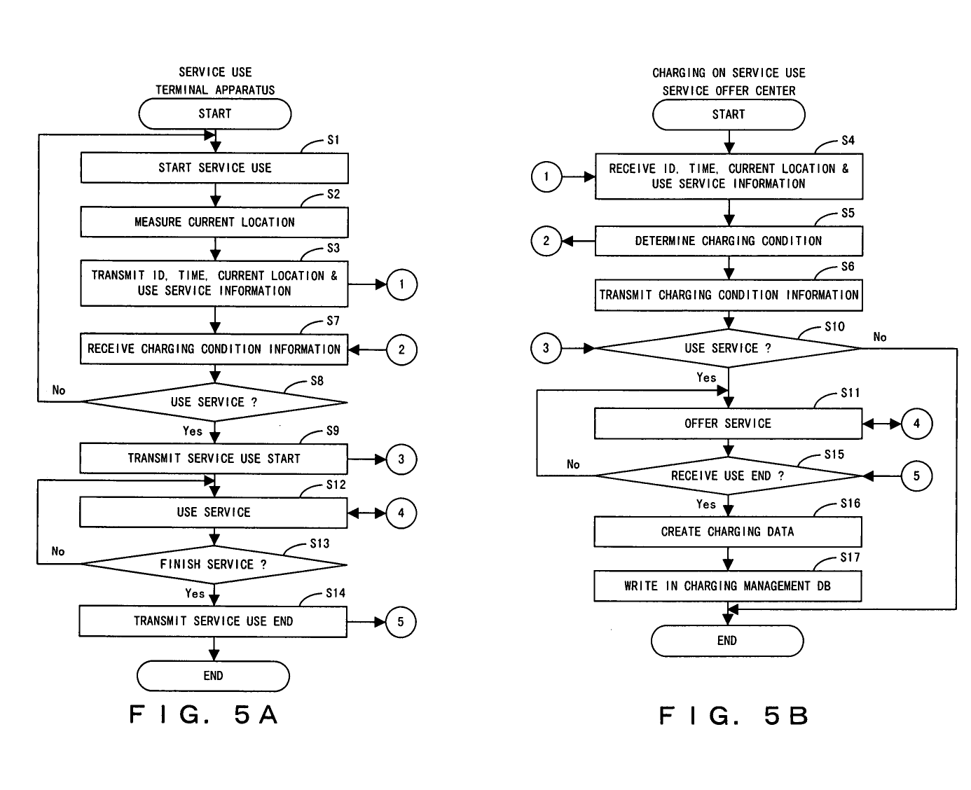

FIGS. 5A and 5B are flowcharts explaining the processing operation according to the present invention.

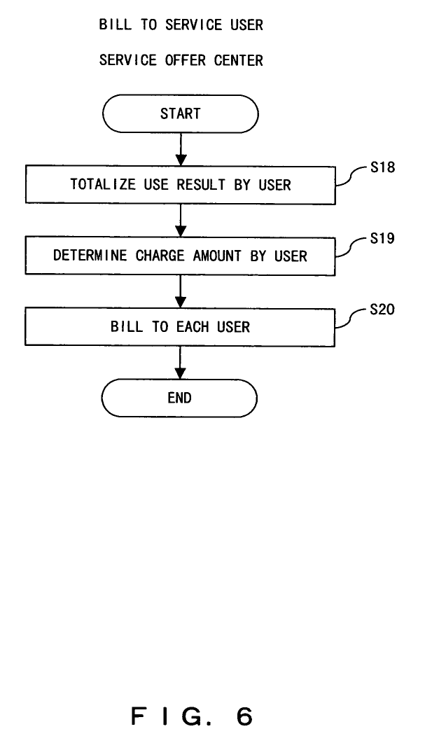

FIG. 6 is a flowchart explaining a billing process to a service user.

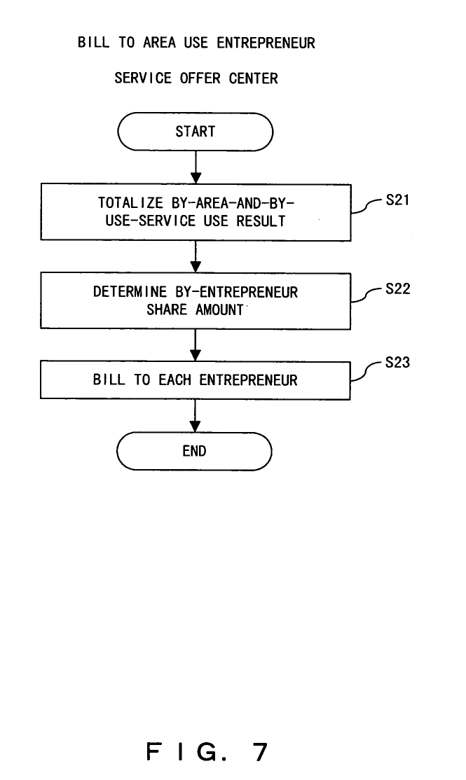

FIG. 7 is a flowchart explaining a billing process of a specific area entrepreneur's share amount.

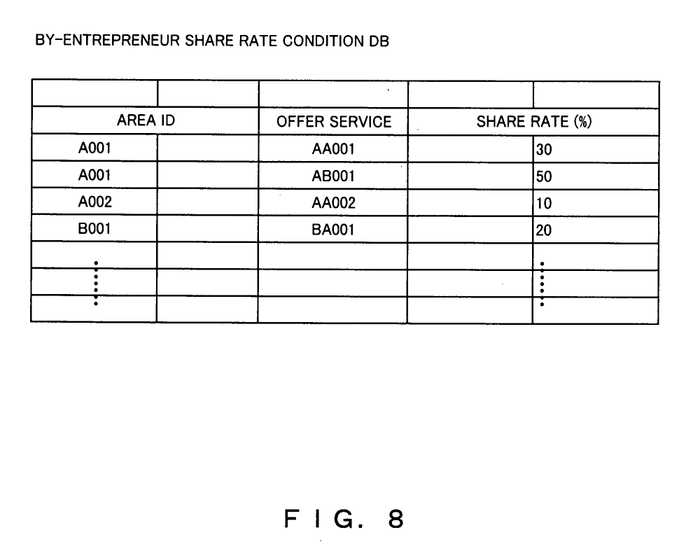

FIG. 8 is a diagram showing a structure example of a by-entrepreneur share rate condition database.

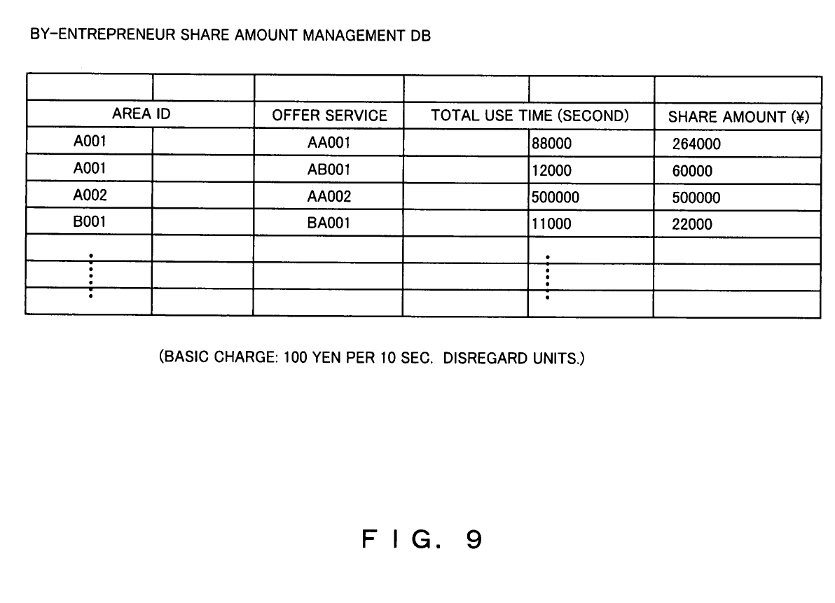

FIG. 9 is a diagram showing a structure example of a by-entrepreneur share amount management database.

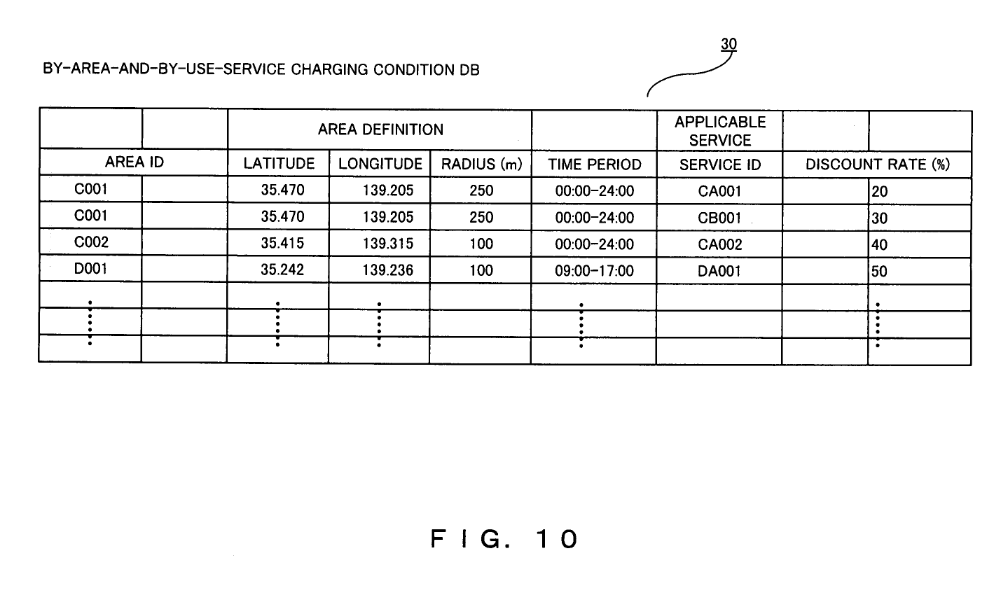

FIG. 10 is a diagram showing a structure example of a by-area-and-by-use-service charging condition database (DB) according to a second embodiment.

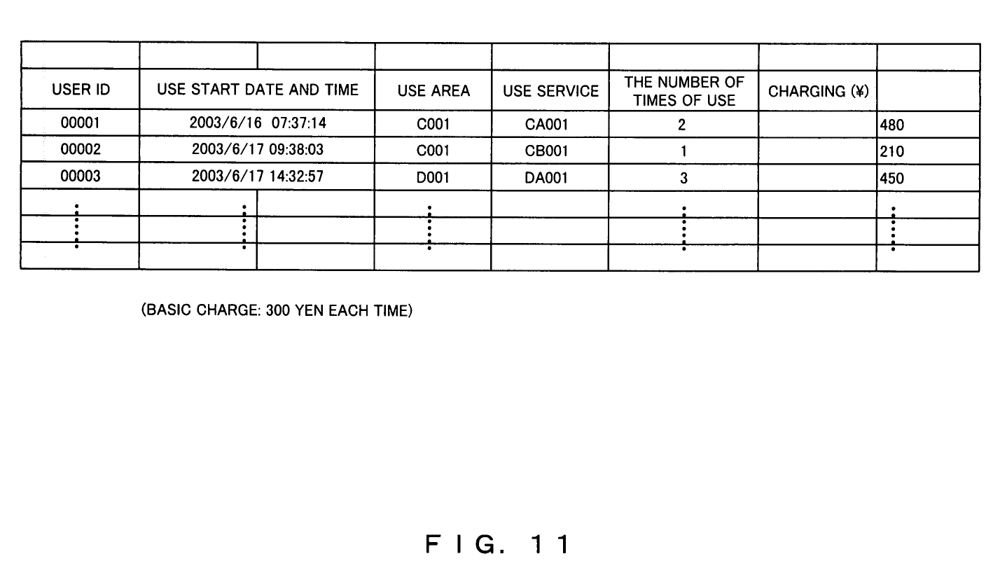

FIG. 11 is a diagram showing a structure example of a charging management database (DB).

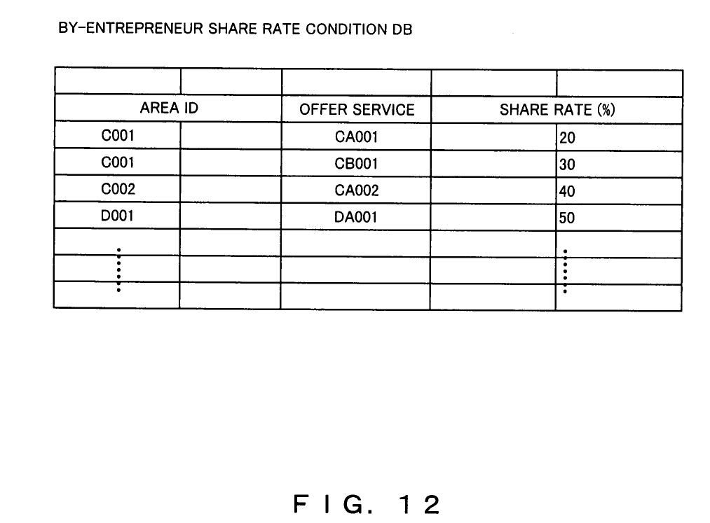

FIG. 12 is a diagram showing a structure example of a by-entrepreneur share rate condition database.

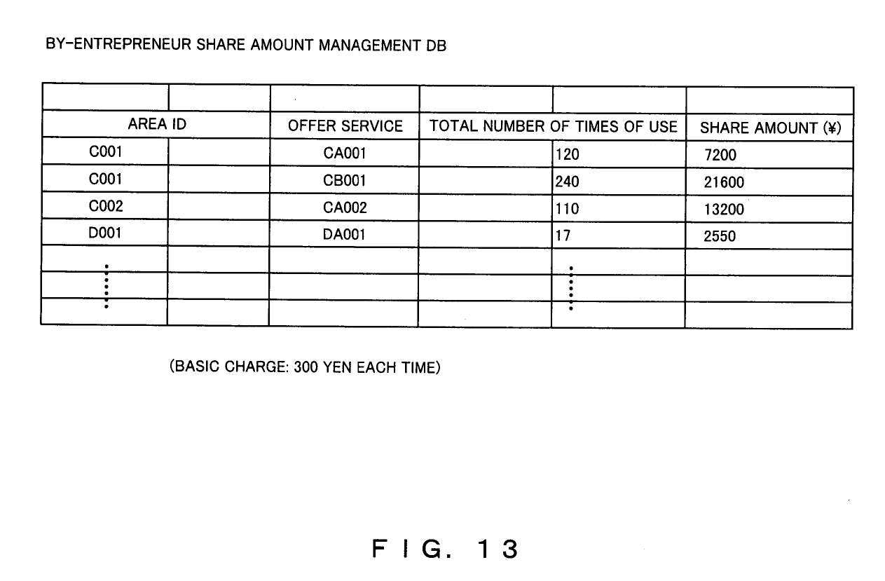

FIG. 13 is a diagram showing a structure example of a by-entrepreneur share amount management database.

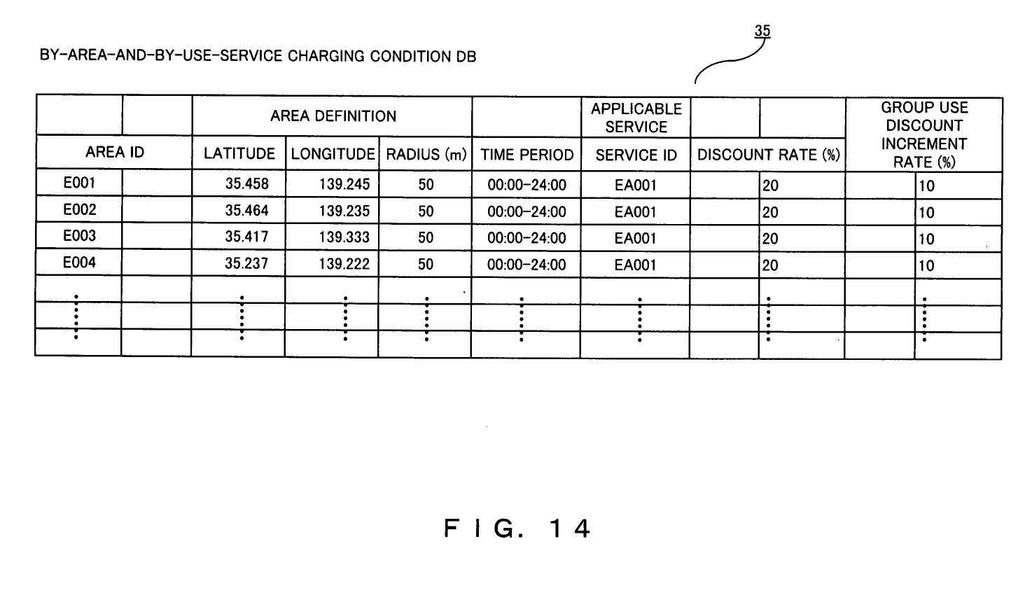

FIG. 14 is a diagram showing a structure example of a by-area-and-by-use-service charging condition database (DB) according to a third embodiment.

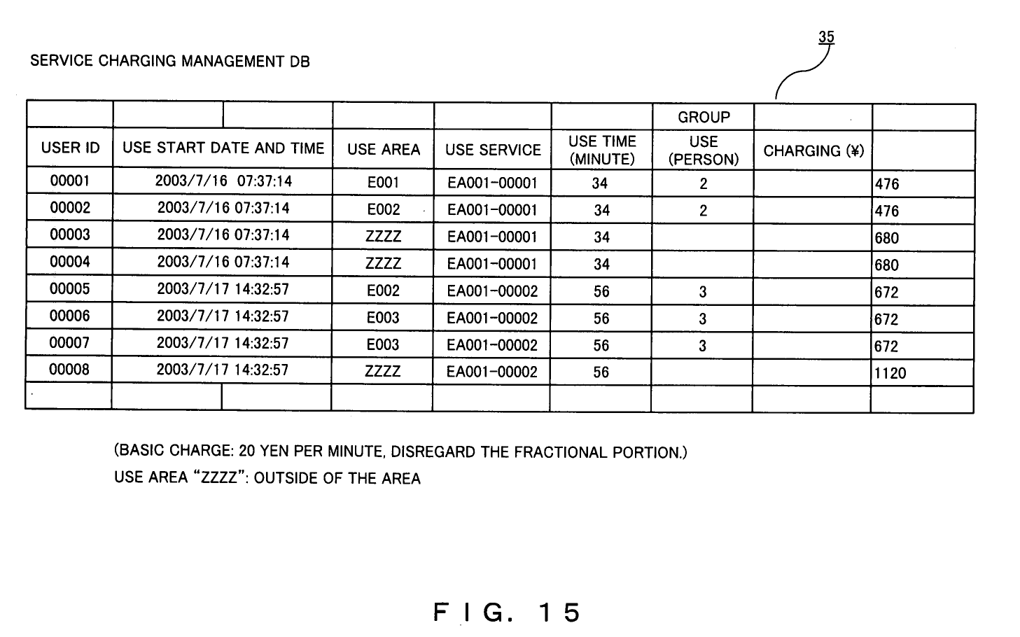

FIG. 15 is a diagram showing a structure example of a charging management database (DB).

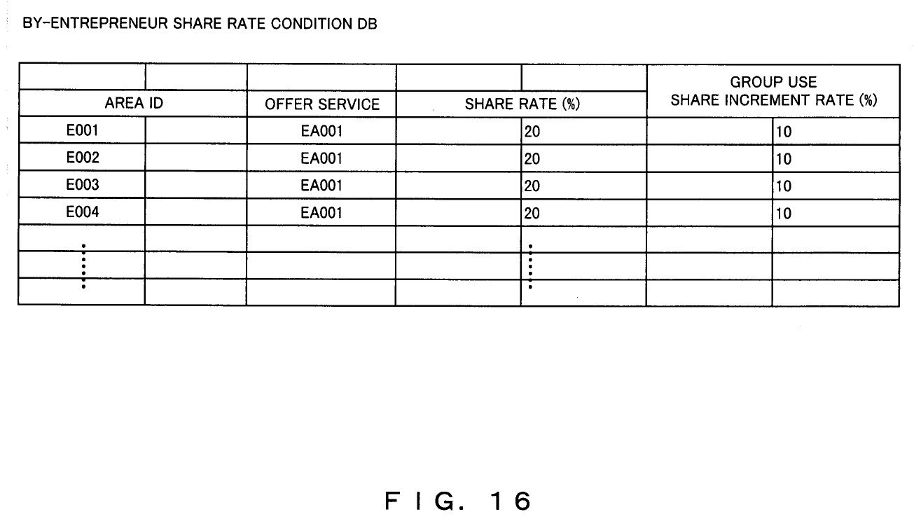

FIG. 16 is a diagram showing a structure example of a by-entrepreneur share rate condition database.

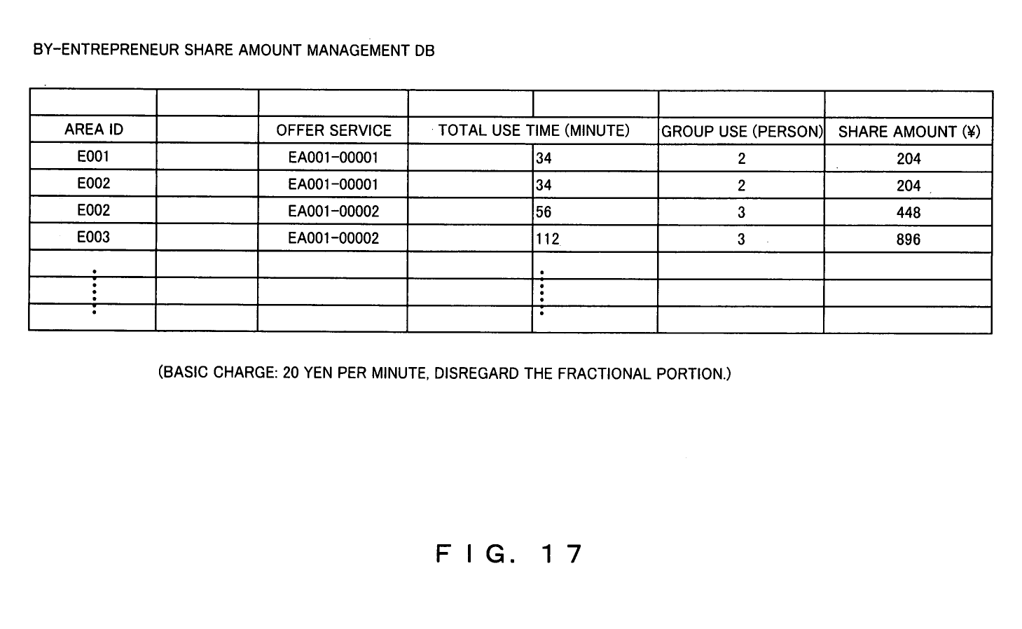

FIG. 17 is a diagram showing a structure example of a by-entrepreneur share amount management database.

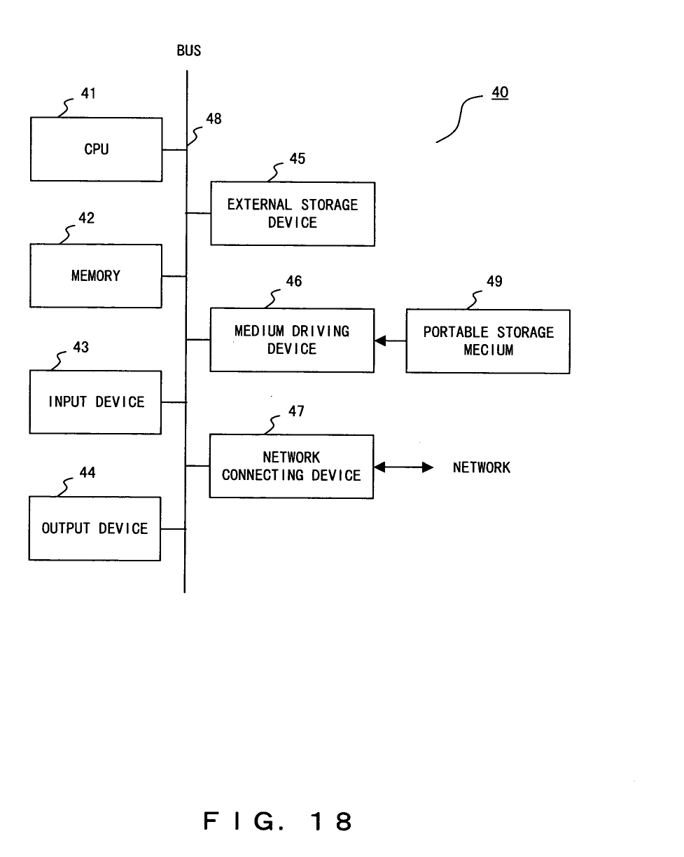

FIG. 18 is a schematic diagram of a management server of a service offer/management center.

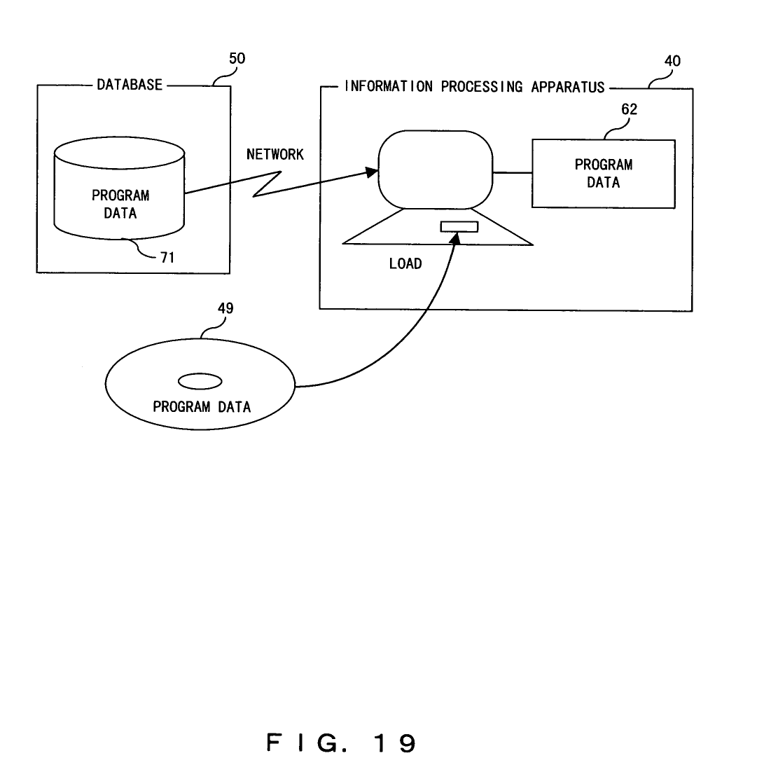

FIG. 19 is a system diagram of a management server of a service offer/management center.

### DESCRIPTION OF THE PREFERRED EMBODIMENTS

Referring to FIGS. 1 to 19, embodiments and operations according to the present invention will be described in detail below.

### First Embodiment

FIG. 1 is a diagram generally illustrating the configuration of a charging system according to this embodiment. This system comprises a specific area entrepreneur 4, a user 2 who receives a service, and a service offer/management center 1 which offers the service. The service offer/management center 1 and a terminal apparatus 3 of the user 2 are connected with each other via a network such as the Internet. Further, a computer of the specific area entrepreneur 4 is also connected with them via the network.

Here, the service offer/management center 1 is the keystone of the charging system based on a user location according to this embodiment as well as offering the service to the user 2, and manages and operates this system. The service offer/management center 1 performs location grasp processing 1a of the user 2, charging table determination processing 1b, service offer processing 1c to the user 2, and charging management 1d.

The location grasp processing 1a grasps a current location of each user based on location information transmitted from the terminal apparatus 3 of the user 2. The charging table determination processing 1b determines a charging table based on the location information and a charging condition described later. The service offer processing 1c offers the user 2 a service that the user 2 desires. The charging management 1d performs charging management of each user or each specific area entrepreneur, based on a service use result.

On the other hand, the terminal apparatus 3 which the user 2 holds or owns is one such as a cellular phone, PDA (personal digital assistants), a personal computer, or the like and is provided with a location identification device such as a GPS (global positioning system). The terminal apparatus 3 transmits location information detected with the GPS to the service offer/management center 1, which is indicated with (1) in FIG. 1, and the service offer/management center 1 uses the location information for the location grasp processing 1a of the user 2. Further, the user 2 receives a service from the service offer/management center 1, which is indicated with (2) in FIG. 1, and pays a charge (¥) for the service, which is indicated with (3) in FIG. 1.

The specific area entrepreneur 4 is set up by applying to the service offer/management center 1 beforehand and is, for example, an operating entrepreneur of a shopping mall in this embodiment. This kind of specific area entrepreneur 4 is billed a share amount described later from the service offer/management center 1, which is indicated with (4) in FIG. 1, and pays the corresponding share amount to the service offer/management center 1, which is indicated with (5) in FIG. 1. Further, the specific area entrepreneur 4 discounts the charge when the user 2 receives the service, which is indicated with (6) in FIG. 1, and the user 2 uses the specific area frequently in terms of the advantage of the discount, which is indicated with (7) in FIG. 1.

FIG. 2 is an explanatory diagram showing the system configuration of the service offer/management center 1 and the terminal apparatus 3. The terminal apparatus 3 comprises a location information acquisition section 10, a time information acquisition section 11, an ID registration section 12, a service utilization section 13, an information transmission section 14, and an information reception section 15. The location information acquisition section 10 uses the GPS (global positioning system) as described above, and measures a current location of the user 2 based on location information from not less than three communications satellites, for example. Further, if necessary, it adjusts the location by receiving a radio wave from an FM station, and thereby measures more accurate location of the user 2. The location information measured in this manner is transmitted from the location information acquisition section 10 to the information transmission section 14 and then transmitted from the information transmission section 14 to the service offer/management center 1.

The time information acquisition section 11 has a clock device and always acquires a current time and transmits time information to the information transmission section 14. The time information is further transmitted from the information transmission section 14 to the service offer/management center 1.

The ID registration section 12 is registration information of the user 2 who is an owner of the terminal apparatus 3, and the user 2 registers an ID number that the user 2 desires beforehand. This registered data is outputted to the information transmission section 14 as necessary, and further transmitted from the information transmission section 14 to the service offer/management center 1.

The service utilization section 13 includes a protocol and software for utilizing the service offered by the service offer/management center 1, and performs display of a list of the offered services, service selection processing, service implementation control processing, etc. For example, JAVA, a web browser, etc. performs these, and a selection of the offered services and an instruction from the user 2 are transmitted through the information transmission section 14 to the service offer/management center 1. On the other hand, service contents and individual service information are inputted to the service utilization section 13 through the information reception section 15. As offered services, there are information of bargains in the shopping mall, information of vacant tables in a restaurant, and the like.

The service offer/management center 1 comprises a user-and-location determination section 16, a charging condition determination section 17, a service offer section 18, etc. The user-and-location determination section 16 determines the current location of the user 2 based on the location information supplied through an information reception section 19. The user-and-location determination section 16 performs the location grasp processing 1a shown in FIG. 1.

The charging condition determination section 17 determines a charging condition based on the location of the user 2 that the user-and-location determination section 16 has determined. This processing is the charging table determination processing 1b shown in FIG. 1, and is performed with reference to a by-area-and-by-use-service charging condition database (DB) 19.

FIG. 3 is a diagram showing a structure example of the by-area-and-by-use-service charging condition database (DB) 19. As shown in FIG. 3, the database 19 comprises “area ID”, “area definition”, “time period”, “applicable service (service ID)”, and “discount rate”. The area ID is a code number of the specific area. For example, “A001” is a specific area of some shopping mall, and “A002” is another specific area of the same shopping mall, and “B001” of the area ID is a specific area of another shopping mall.

In other words, a specific area refers to a whole area where the entrepreneur operates or a part of the operated area.

As shown in FIG. 3, in the case of the shopping mall of area ID “A001”, latitude (35, 450) and longitude (139, 225) where the shopping mall is located and a radius of the area (100 m) are recorded as the area definition. As the time period, “00:00-24:00” is registered.

Further, as the applicable service (service ID), “AA001” is registered. In this embodiment, “AA001” indicates bargain information in the area, and it is utilized, for example, in the case where the user wants to know what kind of bargain is offered in which place at what time. Furthermore, as the discount rate, “30%” is set up. In the case of utilizing the bargain information “AA001” in the specific area at the above time period, the user can receive 30% discount on the service.

Furthermore, “AB001” of the applicable service (service ID) shown in FIG. 3 is information of vacant tables at a restaurant in the area, and it is utilized in the case where the user wants to know how many vacant tables are there in which restaurant at this time.

Moreover, in the case of another area of which area ID is “A002” as well, latitude (35, 420) and longitude (139, 305) where the shopping mall is located and a radius of the area (200 m) are registered as the area definition. As the time period, “00:00-24:00” is registered as well. Further, in the case where the user wants to acquire the bargain information in the area, the user selects “AA002” of the applicable service (service ID), and the discount rate in this case is 10%. In the case of the other specific areas as well, the user can receive a discount on the service on the condition shown in FIG. 3.

The charging condition determination section 17 searches the database 19 based on the location information, the time information, and the applicable service which are provided from the terminal apparatus 3, and determines a charging condition.

The service offer section 18 has a function for offering the user 2 a service that this system can offer, and transmits an information list of services that are possible to be offered to the terminal apparatus 3 through an information transmission section 20. Further, it transmits the service that the user 2 has selected to the user 2 (the terminal apparatus 3) through the information transmission section 20.

A charging management database (DB) 21 records service information that the service offer section 18 offers and retains it as history information. For example, FIG. 4 is a diagram showing a structure example of the charging management database (DB) 21. In the database 21, “user ID”, “use start date and time”, “use area”, “use service”, “use time”, and “charging” are set up, and corresponding data is recorded. Record processing thereof will be described later.

A by-user use result totalization section 22 totalizes a use result by user, using the database recorded in the charging management database (DB) 21. The respective use results of user IDs “00001”, “00002”, and so on, for example, are extracted from the charging management database (DB) 21 and totalized.

A service user charging section 23 determines a charge amount regarding each user based on the totalization result of the by-user use result totalization section 22. Further, a service user billing section 24 bills the user 2 the charge amount created by the service user charging section 23.

A by-area-and-by-use-service use result totalization section 25 totalizes a use result by use entrepreneur, using the database recorded in the charging management database (DB) 21. Use results regarding the respective entrepreneurs of area IDs “A001”, “A002”, and so on, for example, are extracted from the charging management database (DB) 21 and totalized.

An area use entrepreneur charging section 26 determines the charge amount regarding each entrepreneur based on the totalization result of the by-area-and-by-use-service use result totalization section 25. Further, an area use entrepreneur billing section 27 bills the corresponding specific area entrepreneur 4 the charge amount created by the area use entrepreneur charging section 26 via the network.

Further, when the area use entrepreneur charging section 26 sets the charge amount regarding each entrepreneur, the area use entrepreneur charging section 26 refers to a by-entrepreneur share rate condition database (DB) 28. FIG. 8 shows an example of the by-entrepreneur share rate condition database. For example, when an offer service (service ID) of area ID “A0001” is “AA001” (bargain information offer service), the share rate is registered as 30%. When the offer service (service ID) is “AB001” (information service of vacant tables at a restaurant), the share rate is registered as 50%. The rest is shown as well in FIG. 8.

Further, a share amount of each specific area entrepreneur is recorded in a by-entrepreneur share amount management database 29. The by-entrepreneur share amount management database 29 will be described later.

In the above-mentioned structure, processing operation of this system will be described below.

FIGS. 5A and 5B are flowcharts explaining processing according to this embodiment. FIG. 5A shows processing of the terminal apparatus 3, and FIG. 5B shows processing of the service offer/management center 1. First, the user 2 uses a service, operating the terminal apparatus 3 (Step (hereafter called S) 1). For example, when the terminal apparatus 3 is a cellular phone, it connects to a server in the management center 1 via the network using an HTTP protocol for the cellular phone.

Next, a current location of the user 2 (the terminal apparatus 3) is measured (S2). This measurement is performed with the GPS or the like in the terminal apparatus 3 used, as described above. Here, suppose that the user 2 is in “A001” of the shopping mall.

Next, ID information, time information, current-location information, and use service information are transmitted to the service offer/management center 1 (S3). Here, the time information is acquired by the time information acquisition section 11 and transmitted to the service offer/management center 1 along with the current-location information. As for the ID information, the ID number of the user read out from the ID registration section 12 is transmitted. Further, the user selects the use service information referring to, for example, a service list displayed on a display of the terminal apparatus 3.

The service offer/management center 1 receives the above-mentioned information and determines a charging condition based on the information (S4, S5). The service offer/management center 1 determines the charging condition based on the current-location information, the time information, and the use service information referring to the by-area-and-by-use-service charging condition database (DB) 19 shown in FIG. 3.

For example, when it is determined that the user 2 is in the area of “A001” of the shopping mall from the location information, and if a designated service is “AA001” (bargain information offer service), the information registered on the top line of the database shown in FIG. 3 is referred to and the corresponding “discount rate” 30% is selected. On the other hand, if the user 2 designates “AB001” (information service of vacant tables at a restaurant), the information registered on the second line of the database shown in FIG. 3 is referred to and the corresponding “discount rate” 50% is selected.

Further, in the example shown in FIG. 3, the set time period is “00:00-24:00”. Since all time is included, the time information does not affect the discount rate in the example; however, in a case where the time period is set to another period, the discount rate is valid within the set time period.

The information of the charging condition (“discount rate”) that is determined in the above manner is transmitted to the terminal apparatus 3 via the network (S6).

The terminal apparatus 3 receives the information of the charging condition (“discount rate”) (S7), and the user 2 determines whether to use the service or not (S8). Here, the user 2 confirms the charging condition (“discount rate”) displayed on the display of the terminal apparatus 3. If the user does not use the service, the user performs an end instruction, for example, and makes the process move to the beginning (NO at S8, S1).

On the other hand, after confirming the charging condition (“discount rate”), if the user uses the service (YES at S8), the user transmits a start instruction for using the service (S9). This instruction is transmitted to the server in the service offer/management center 1 and the server offers the service. (YES at S10, S11).

As services that the server offers to the terminal apparatus 3, there are various kinds of services as described above. There may occur multiple times of data transfer between the service offer/management center 1 and the terminal apparatus 3, depending on services (S11, S12).

Afterward, when the use of the service is completed (YES at S13), the terminal apparatus 3 transmits an end of the service use (S14). Upon receiving the end of the service use (YES at S15), the service offer/management center 1 creates charging data (S16) and records it in the charging management database (DB) 21 (S17).

For example, in an example shown in FIG. 4, the user of user ID “00001” uses the service of “AA001” (the bargain information service) for 50 seconds from 7:37:14 on May 16, 2003 and its record is registered in the database. In this case, the discount rate is 30% shown in FIG. 3. Assuming that a basic charge of the service is 100 yen every 10 seconds, the charge (¥) is 350 yen (100 yen×5×0.7), and the charge amount is recorded in the database shown in FIG. 4.

Further, in a next example shown in FIG. 4, the user of user ID “00002” uses the service of “AB001” (the information service of vacant tables at a restaurant) for 30 seconds from 9:38:03 on May 17, 2003 and this information is recorded in the database. In this case, the discount rate is 50% shown in FIG. 3. The charge (¥) is 150 yen (100 yen×3×0.5), and the charge data is recorded in the database shown in FIG. 4.

In the same manner, use information of the user 2 is recorded in the database shown in FIG. 4 in sequence along with the charge (¥) information.

When the use information and the charge (¥) information of the user 2 are recorded in the charging management database (DB) 21 and the information records within a predetermined period are completed, the by-user use result totalization section 22 totalizes the charge amount to the service user based on the data recorded in the charging management database (DB) 21 and bills the user. For example, the totalized charge amount is displayed on the terminal apparatus 3 and then a request for paying the charge into a bank account to the user is made, or a bill to the user is made out based on the charge amount. Further, the system may be constructed such that when the totalized charge amount is debited from the user's account which is set beforehand, its receipt is displayed on the terminal apparatus.

FIG. 6 is a flowchart explaining this process. First, use result by user is totalized (S18). For example, in an example of the database shown in FIG. 4, the charge amount to the user of user ID “00001” is totalized from the information of the use area and the use service (350 yen+700 yen+ . . . ). In the same manner, the charge amount regarding another user is totalized, so that the charge amount by user is determined (S19).

The charge amount determined in the above manner is billed to each user (S20), and the user pays for the service that the user has used. However, according to the charging system of this embodiment, by using a service in the specific area, the user can receive a discount at a predetermined rate and thus get an advantage.

On the other hand, the specific area entrepreneur 4 is billed from the service offer/management center 1 according to a flowchart shown in FIG. 7. This process is performed by the by-area-and-by-use-service use result totalization section 25, and use results are totalized by area and by use service (S21).

When the by-area-and-by-use-service use result totalization section 25 totalizes the share rate by area, the by-area-and-by-use-service use result totalization section 25 refers to the database shown in FIG. 8, and totalizes the share amount by area/and by use service.

FIG. 9 shows an example of the database in which use time and share amounts by entrepreneur and by offer service are totalized and recorded. As shown in FIG. 9, in the case of the applicable service (service ID) of “AA001” (the bargain information service) in the specific area of “A001”, the total share amount is 264,000 yen. Further, in the case of the applicable service (service ID) of “AB001” (the information service of vacant tables at a restaurant) in the same specific area of “A001”, the total share amount is 60,000 yen. The rest of the share amount is shown as well in FIG. 9.

Next, the area use entrepreneur charging section 26 determines the share amount by use entrepreneur, and the area use entrepreneur billing section 27 bills the corresponding specific area entrepreneur 4 the share amount (S23). Accordingly, the specific area entrepreneur 4 pays the share amount on the basis of the bill. However, the specific area entrepreneur can promote attracting users to increase sales in the shopping mall.

On the other hand, the service offer/management center 1 promotes participation of specific area entrepreneurs 4 into the charging system which the service offer/management center 1 operates to encourage tie-ups between the specific area entrepreneurs 4 and the service offer/management center 1, and thus can offer services at more reasonable prices.

As described above, according to this embodiment, the service offer/management center 1, the user 2, and the specific area entrepreneur 4 can get the respective merits, and thus an extremely effective system can be constructed.

Further, in this embodiment, the example that applies to services in a shopping mall is described; however, the system is not limited to the shopping mall, and may be applied to services in, for example, theme parks, schools, libraries, public parks, etc.

### Second Embodiment

Next, a second embodiment of the present invention will be described. The system configuration diagrams shown in FIG. 1 and FIG. 2 will be referred to in this embodiment as well.

In this embodiment, for example, an open-air swimming pool is applied as the specific area. As examples of the applicable service (service ID), a movie distribution service and a book distribution service are employed. A detailed description will be made below.

FIG. 10 shows an example of a by-area-and-by-use-service charging condition database (DB) 30 according to this embodiment. In this embodiment as well, the database 30 comprises “area ID”, “area definition”, “time period”, “applicable service (service ID)”, and “discount rate”. In the area ID, a code number of the specific area is registered. For example, “C001”, “C002”, etc. are registered, and “C001” is, for example, a code number of an open-air swimming pool at a hotel. Further, “C002” is an area code number of a pool at another hotel.

Furthermore, in the same manner as in the first embodiment, latitude (35, 470) and longitude (139, 205) where the swimming pool of the hotel is located and a radius of the area (250 m) are recorded as the area definition. As the time period, “00:00-24:00” is registered.

Further, as the applicable service (service ID), “CA001” is registered. In this embodiment, “CA001” indicates a movie distribution service, and 20% is set up as the discount rate. Moreover, “CB001” indicates a book distribution service, and 30% is set up as the discount rate.

Next, in the above-mentioned structure, processing operation of this system will be described below. This processing is performed base on the flowcharts in FIGS. 5A and 5B as well.

First, the user 2 uses a service, operating the terminal apparatus 3 (S1). Next, a current location of the user 2 (the terminal apparatus 3) is measured (S2). The location information which designates that the user 2 is at the pool of the hotel, for example, ID information of the user 2, time information, and information of the applicable service (service ID) are transmitted to the service offer/management center 1 (S3).

The service offer/management center 1 determines a charging condition based on the current-location information (location information) and the information of the applicable service (service ID) (S4, S5). The service offer/management center 1 determines the charging condition referring to the by-area-and-by-use-service charging condition database (DB) 30 shown in FIG. 10.

The information of the charging condition (“discount rate”) that is determined in the above manner is transmitted to the terminal apparatus 3 via the network (S6), and the user 2 determines whether to use the service or not (S8). If the user uses the service (YES at S8), the user transmits a start instruction for using the service (S9).

For example, as described above, in the case where the user 2 desires the movie distribution, “CA001” is applied, and in the case where the user 2 desires the book distribution, “CB001” is applied. Afterward, when the use of the service is completed (YES at S13), the terminal apparatus 3 transmits an end of the service use (S14). Upon receiving the end of the service use (YES at S15), the service offer/management center 1 creates charging data (S16) and records it in the charging management database (DB) 21 (S17).

For example, in an example shown in FIG. 11, the user of user ID “00001” uses the service of “CA001” (the movie distribution service) twice from 7:37:14 on Jun. 16, 2003 and this information is recorded in the database. In this case, the discount rate is 20% shown in FIG. 10. Assuming that a basic charge of the movie distribution service is 300 yen each time, the charge amount (¥) is 480 yen (300 yen×2×0.8), and this data is recorded in the database shown in FIG. 11.

Further, in a next example shown in FIG. 11, the user of user ID “00002” uses the service of “CB001” (the book distribution service) once from 9:38:03 on Jun. 17, 2003 and this information is recorded in the database. In this case, the discount rate is 30% shown in FIG. 10. Assuming that a basic charge of the book distribution service is 300 yen each time, the charge amount (¥) is 210 yen (300 yen×1×0.7), and this data is recorded in the database shown in FIG. 11. In the same manner, use information of the user 2 is recorded in the database shown in FIG. 11 in sequence along with the charge (¥) information.

When the use information and the charge (¥) information of the user 2 are recorded in the charging management database (DB) 31 and the information records within a predetermined period are completed, the by-user use result totalization section 22 totalizes the charge amount to the service user based on the data recorded in the charging management database (DB) 21 and bills the user. This process is shown by the flowchart in FIG. 6. First, use result by user is totalized (S18), and then the charge amount is billed to the corresponding user 2 (S20). Therefore, in this embodiment as well, the user pays for the service that the user has used; however, according to the charging system of this embodiment, by using a service in the specific area, the user 2 can receive a discount at a predetermined rate and thus get an advantage.

On the other hand, the specific area entrepreneur 4 is billed from the service offer/management center 1 according to the flowchart shown in FIG. 7. Use results are totalized by area and by use service (S21, S22), and then the corresponding specific area entrepreneur 4 is billed the share amount (S23).

In this case, the area use entrepreneur charging section 26 calculates based on the by-entrepreneur share rate condition database shown in FIG. 12 and registers the totalized share amounts shown in FIG. 13. For example, in the case of the applicable service (service ID) of “CA001” in the specific area of “C001”, the total share amount is 7,200 yen. Further, in the case of the applicable service (service ID) of “CB001” in the same specific area of “C001”, the total share amount is 21,600 yen. The rest of the share amount is shown as well in FIG. 13.

Therefore, in this embodiment as well, the specific area entrepreneur 4 pays the share amount on the basis of the bill; however, the specific area entrepreneur can promote attracting users to increase sales of the swimming pool in the hotel.

On the other hand, the service offer/management center 1 promotes participation of specific area entrepreneurs 4 into the charging system which the service offer/management center 1 operates to encourage tie-ups between the specific area entrepreneurs 4 and the service offer/management center 1, and thus can offer services at more reasonable prices.

Further, in this embodiment, the open-air swimming pool in the hotel is referred to; however, the system may be constructed such that discounts on an encyclopedia distribution services, translation services, etc. are offered in schools.

Furthermore, the system may be applied to discount offers on content services for children in theme parks, and in this case, it can be used effectively by showing the contents for children during the waiting time for attractions, for example.

Moreover, this system may be applied to discount offers on entertainment distribution services at fishponds, and can provide amusement for anglers, for example.

Moreover, the system may be applied to guides of teams and members and entertainment services in sports arenas such as soccer stadiums, and, for example, can provide amusement before a game begins.

Furthermore, this system may be constructed such that the system is applied to bargain information offer services, etc. in flea markets.

### Third Embodiment

Next, a third embodiment of the present invention will be described. The system configuration diagrams shown in FIG. 1 and FIG. 2 will be referred to in this embodiment as well.

This embodiment shows a configuration that is applied to, for example, a coffee shop (coffee chain store) as the specific area and a mah-jongg game service by communication as the applicable service (service ID). A detailed description will be made below.

FIG. 14 shows an example of a by-area-and-by-use-service charging condition database (DB) 35 according to this embodiment. In this embodiment, the database 35 comprises “area ID”, “area definition”, “time period”, “applicable service (service ID)”, and “discount rate”, and further comprises “group use discount increment rate”.

In the area ID, a code number of the specific area is registered. For example, “E001” to “E004” are code numbers of the coffee shop (coffee chain store). Further, as the area definition, a latitude and a longitude of each chain store and a radius of the area are registered, and as the time period, “00:00-24:00” is registered.

Further, as the applicable service (service ID), “EA001” is registered. In this embodiment, “EA001” indicates the mah-jongg game service. As the discount rate, 20% is set up, and further, 10% is set up as the group use discount increment rate. As for the group use discount increment rate, it increases as the number of group members increases. For example, group use discount increment rates are 10%, 20%, and 30%, in the cases of two members, three members, and four members, respectively.

Next, in the above-mentioned structure, processing operation of this system will be described below. The following explanation is also based on the processes in FIGS. 5A and 5B; however, step numbers are omitted in the explanation.

As in the case of the previous embodiment, the user 2 uses a service, operating the terminal apparatus 3, and transmits a current location of the user 2 (the terminal apparatus 3) to the service offer/management center 1. Through the location information, the service offer/management center 1 recognizes that the user of user ID “00001” is at the coffee shop (coffee chain store) “E001”, for example. Further, the service offer/management center 1 recognizes that the user of user ID “00002” is at the coffee shop (coffee chain store) “E002”, for example. Furthermore, the service offer/management center 1 recognizes that the user of user ID “00003” is at the coffee shop (coffee chain store) “E003”, for example and that the user of user ID “00004” is at the coffee shop (coffee chain store) “E004”, for example.

The service offer/management center 1 determines a charging condition based on the current-location information (location information) and the information of the applicable service (service ID). The service offer/management center 1 determines the charging condition referring to the by-area-and-by-use-service charging condition database (DB) 35 shown in FIG. 14.

The information of the charging condition (“discount rate”) that is determined in the above manner is transmitted to the terminal apparatus 3 via the network, and each user determines whether to use the service, and if the user uses the service, the user transmits a start instruction for using the service.

Here, suppose that four users whose user IDs are “00001” to “00004” use the service to play the mah-jongg game. In this case, when the mah-jongg game ends, the service offer/management center 1 creates charging data and records it in the charging management database (DB) 36 shown in FIG. 15.

For example, in an example shown in FIG. 15, four users of user IDs “00001” to “0004” use the mah-jongg game (applicable service “EA001-00001”) for 34 minutes from 7:37:14 on Jul. 16, 2003 and each charge amount is recorded in the database.

Further, in the example, the users of user IDs “00001” and “00002” use the service in a group of two persons, and since the basic charge is 20 yen per minute, the charge amount is 476 yen (20 yen×34×0.7). Furthermore, the users of user IDs “00003” and “00004” use the service outside the specific area; therefore, the discount is not applied, and the charge amount is 680 yen (20 yen×34).

Furthermore, in another example shown in FIG. 15, users of user IDs “00005 to “00007” use the mah-jongg game (applicable service “EA001-00002”) for 56 minutes from 14:32:57 on Jul. 17, 2003. Since the users use the service in a group of three persons, the group discount rate 20% is added to the discount rate 20%; therefore, the charge amount to each user 2 is 672 yen (20 yen×56×0.6). Further, the other user (user ID “00008”) who joins the mah-jongg game (applicable service “EA001-00002”) uses the service outside the specific area; therefore, the discount is not applied, and the charge amount is 1,120 yen (20 yen×56).

The charge amount is recorded in the charging management database (DB) 36 shown in FIG. 15 in sequence, and when the records within a predetermined period are completed, the by-user use result totalization section 22 totalizes the charge amount by user to bill each user. Therefore, in this embodiment as well, the user pays for the service that the user has used; however, according to the charging system of this embodiment, by using a service in the specific area, the user 2 can receive a discount at a predetermined rate and thus get an advantage. Further, by using the service in a group in this embodiment, the user 2 can receive a group discount and thus get more advantage.

On the other hand, the specific area entrepreneur 4 is billed from the service offer/management center 1. This processing totalizes use results by area and by use service, and then bills the corresponding specific area entrepreneur 4 the share amount.

FIG. 16 shows an example of the by-entrepreneur share rate condition database in this case. The share amount of the entrepreneur is calculated on the basis of the share rate, and the calculated share amounts are shown in FIG. 17. For example, in the case of the entrepreneur of area ID “E001”, the applicable service (service ID) of “EA001-00001” is used for 34 minutes with a discount; therefore, the share amount is 204 yen. In the case of the entrepreneur of area ID “E002”, the applicable service (service ID) of “EA001-00001” is used for 34 minutes with a discount; therefore, the share amount is 204 yen as well. The rest of the share amount is shown as well in FIG. 17.

Therefore, in this embodiment as well, the specific area entrepreneur 4 pays the share amount on the basis of the bill; however, the specific area entrepreneur can promote attracting users since users can use services with discounts at the coffee shop of the entrepreneur in this embodiment to increase the sales.

Further, in this embodiment, the coffee shop (coffee chain store) is described; however, the system can be applied to offer services of games such as a Japanese board game resembling chess, Go, etc., and chat use services in theme parks.

Furthermore, in the first to second embodiments, the charging to the user 2 is the fixed discount by applicable services of the specific area entrepreneur; however, the system may be constructed such that the discount rate varies depending on characteristics of the specific area. For example, the system may be constructed such that the discount rate varies with the specific area or the weather.

Moreover, the system may be constructed such that the discount rate varies with use characteristics such as the number of users to the specific area. For example, the system may be constructed such that the discount rate varies with the number of times of service use by the same user, or varies with the number of times of service use in the same specific area, or the number of times of service use within a specific period. Further, the system may be constructed such that the discount rate varies by the user using a specific service in the specific area predetermined times (for example, 10 times).

As for the specific area entrepreneur 4's share amount, the system may be constructed such that the share rate also varies depending on a characteristic of the specific area. For example, the system may be constructed such that the share rate varies with a size of the specific area. Further, the system may be constructed such that the share rate varies with regional characteristics of the specific area. For example, the system may be constructed such that the share rate increases with services that are related to regional characteristics or residents of the area, and on the other hand, decreases with services that are not related to regional characteristics or residents of the area.

Furthermore, the process described in this embodiment can be performed with a computer (information processing apparatus) having a configuration shown in FIG. 18. A computer 40 shown in FIG. 18 comprises a CPU 41, a memory 42, an input device 43, an output device 44, an external storage device 45, a medium drive device 46, and a network connection device 47, and these are connected with one another via a bus 48.

The memory 42 comprises, for example, a ROM (Read Only Memory), RAM (Random Access Memory), etc., and stores a program and data which are used in the process. The CPU 41 performs the above-mentioned process by executing a program utilizing the memory 42.

The external storage device 45 is, for example, a magnetic disk device, an optical disc device, a magneto-optical disc device, etc. It is possible to store the program and the data in the external storage device 45, and as necessary, load them into the memory 42 to use them.

The medium drive device 46 drives a transportable storage medium 49, and accesses the storage content. As the transportable storage medium 49, a storage medium, which an arbitrary computer can read, such as a memory card, a memory stick, a flexible disk, a CD-ROM (Compact Disc Read Only Memory), an optical disc, a magneto-optical disc, a DVD (Digital Versatile Disk), etc. is used.

It is possible to store the program and the data in the transportable storage medium 49, and as necessary, load them into the memory 42 to use them.

The network connection device 47 communicates with an external apparatus via an arbitrary network (line), and performs data conversion of the communication. Further, as necessary, the program and the data may be received from the external apparatus and loaded into the memory 42 to be used.

FIG. 19 is a diagram explaining a transmission signal and a storage medium that can provide a program and data to the computer shown in FIG. 18 and can be read by the computer.

By providing the program and the data stored in each table to the computer 40 in the following manner, it is possible to have the computer 40 perform the above functions. To do so, the program and the data are stored beforehand in the storage medium 49 which the computer can read.

As shown in FIG. 19, the program and the like are read out from the storage medium 49 to the computer 40 through the medium drive device 46 and stored temporarily in the memory 42 or the external storage device 45 of the computer 40, and then read out to the CPU 41 of the computer 40 to be performed.

Further, instead of having the computer read out the program from the storage medium 49, it is also possible to download the program from a database 50 which a provider of the program (data) owns, via a communication line.

The embodiments of this invention have been described; however, this invention is not limited to the above embodiments, and it is possible to make various other changes.

As described above, according to the present invention, the user can get an advantage that the user can receive a discount by using the service in the specific area. Further, the specific area entrepreneur can promote attracting users to increase sales. Furthermore, the service offer/management center can promote the participation into the charging system of the present invention with the tie-up between the specific area entrepreneur and the service offer/management center, and can collect the share amount from the specific area entrepreneur.

1. An information processing apparatus in a charging system in which the information processing apparatus which offers a service, a terminal apparatus of a user who receives the service, and a computer of an entrepreneur in a specific area are connected with one another via a network, the information processing apparatus comprising:
storage means for storing a discount rate of a use charge for a service offer based on the service and location information of the specific area;
calculation means for calculating a charge amount with a corresponding discount rate after searching the storage means according to location information and a service selected by the user which are transmitted from the terminal apparatus of the user;
first billing means for totalizing the charge amount about each user and billing the user; and
second billing means for totalizing a share amount corresponding service use in the specific area, about each entrepreneur and billing the entrepreneur.

2. The information processing apparatus according to claim 1, wherein the discount rate which the storage means stores includes also time information and the calculation means selects the discount rate with the time information to make a calculation.

3. The information processing apparatus according to claim 1 or claim 2, wherein the discount rate varies with a characteristic of the specific area.

4. The information processing apparatus according to claim 1 or claim 2, wherein the discount rate varies with a use characteristic of the specific area.

5. The information processing apparatus according to claim 1, or claim 2 wherein where a service that applies for use among a plurality of users is used, an extra discount rate is set up in the case of group use.

6. The information processing apparatus according to claim 5, wherein the extra discount rate varies with the number of group members.

7. The information processing apparatus according to claim 1 or claim 2, wherein the entrepreneur's share amount is calculated based on a share rate which is set up beforehand.

8. The information processing apparatus according to claim 7, wherein the share rate varies with a characteristic of the specific area.

9. The information processing apparatus according to claim 7, wherein the share rate varies with a regional characteristic of the specific area.

10. A charging method based on a user location in a system in which an information processing apparatus which offers a service, a terminal apparatus of a user who receives the service, and a computer of an entrepreneur in a specific area are connected with one another via a network, the charging method comprising:
a step of storing a discount rate of a use charge for a service offer in a storage means based on the service and location information of the specific area;
a calculation step of calculating a charge amount with a corresponding discount rate after searching the storage means according to location information and a service selected by the user which are transmitted from the terminal apparatus of the user;
a first billing step of totalizing the charge amount about each user and billing the user; and
a second billing step of totalizing a share amount corresponding service use in the specific area, about each entrepreneur and billing the entrepreneur.

11. The charging method based on the user location according to claim 10, wherein the discount rate includes also time information and the calculation step includes selecting the discount rate with the time information.

12. A charging program used in an information processing apparatus in a charging system in which the information processing apparatus which offers a service, a terminal apparatus of a user who receives the service, and a computer of an entrepreneur in a specific area are connected with one another via a network, the charging program comprising:
a function of storing a discount rate of a use charge for a service offer in a storage means based on the service and location information of the specific area;
a calculation function of calculating a charge amount with a corresponding discount rate after searching the storage means according to location information and a service selected by the user which are transmitted from the terminal apparatus of the user;
a first billing function of totalizing the charge amount about each user and billing the user; and
a second billing function of totalizing a share amount corresponding service use in the specific area, about each entrepreneur and billing the entrepreneur.

13. A terminal apparatus in a charging system in which an information processing apparatus which offers a service, the terminal apparatus of a user who receives the service, and a computer of an entrepreneur in a specific area are connected with one another via a network, the terminal apparatus comprising:
location detection means for detecting a location of the user, which the user holds;
service selection means for selecting the service which the information processing apparatus offers; and
transmission means for transmitting to the information processing apparatus the location information which the location detection means has detected and the service which the service selection means has selected.

14. The terminal apparatus according to claim 13, wherein the terminal apparatus measures also time and the transmission means outputs also the time information to the information processing apparatus.

15. A program used in a terminal apparatus in a charging system in which an information processing apparatus which offers a service, the terminal apparatus of a user who receives the service, and a computer of an entrepreneur in a specific area are connected with one another via a network, the program comprising:
a location detection function for detecting a location of the terminal apparatus;
a service selection function for selecting the service which the information processing apparatus offers; and
a transmission function for transmitting to the information processing apparatus the location information detected by the location detection function and the service selected by the service selection function.

16. The program according to claim 15, further comprising a program for processing the service which the information processing apparatus offers.
